(19) United States
(12) Patent Application Publication
(10) Pub. No.: US 2009/0017860 A1
(43) Pub. Date: Jan. 15, 2009

(54) Intelligent Power-Aware Downloading for Mobile Communication Devices

(75) Inventor: Gary R. Cole, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/774,754

(22) Filed: Jul. 9, 2007

(51) Int. Cl. H04B 7/00

(52) U.S. Cl. 455/522

(57) ABSTRACT

A mobile communication device includes intelligent, power-aware download capability for downloading or streaming content. Music, video and other media content is made available by the content provider with multiple content qualities. The mobile communication device monitors its own power availability status, determines a desired content quality, and downloads the media content with the desired content quality.

### BACKGROUND

The present invention relates generally to a system and method for downloading media content from a content provider to a mobile communication device.

The introduction of enhanced data capabilities for wireless networks has resulted in an explosion of wireless applications for users of mobile devices such as cell phones, Personal Digital Assistants (PDAs), laptop computers, etc. Mobile device users are now able to browse web pages, compose and read e-mail messages, chat with their friends and acquaintances, download music and/or video files from Internet servers, and send digital photographs or images to their friends.

The convergence of communication devices with handheld computing devices and media players is one factor driving the demand for data services. Cell phones are no longer used simply for voice communications, but are frequently used as media players and hand-held computers. With converged devices, users can wirelessly access content providers on the Internet and download audio and/or video files for playback on their mobile devices.

Unlike typical desktop computers, mobile communication devices have limited power. Downloading video and/or audio files drains the available power of the mobile communication device. In some instances, downloading a particular file may not be possible or may be aborted due to insufficient power.

### SUMMARY

The present invention provides an intelligent, power-aware downloading capability for downloading or streaming media content to mobile communication devices. Music, video, and other media content available in multiple content qualities is made available by a content provider. In general, media content with higher content quality requires greater bandwidth and greater power to download than lower content quality. The mobile communication device monitors its own power availability status, determines a desired content quality, and downloads the media content with the desired content quality. If the mobile communication device is connected to an external power supply, and thus has virtually unlimited power, it may select a high content quality. Conversely, if the mobile communication device is operating on battery power and the current power level of the battery is low, the mobile communication device may select a low content quality. In certain applications, such as streaming applications, the content quality may be changed while downloading or streaming is in progress.

### BRIEF DESCRIPTION OF THE DRAWINGS

FIG. 1 illustrates an exemplary mobile communication network.

FIG. 2 illustrates an exemplary method for downloading media content.

FIG. 3 illustrates another exemplary method for downloading media content.

FIG. 4 illustrates an exemplary content provider.

FIG. 5 illustrates another exemplary content provider.

FIG. 6 illustrates an exemplary mobile communication device.

### DETAILED DESCRIPTION

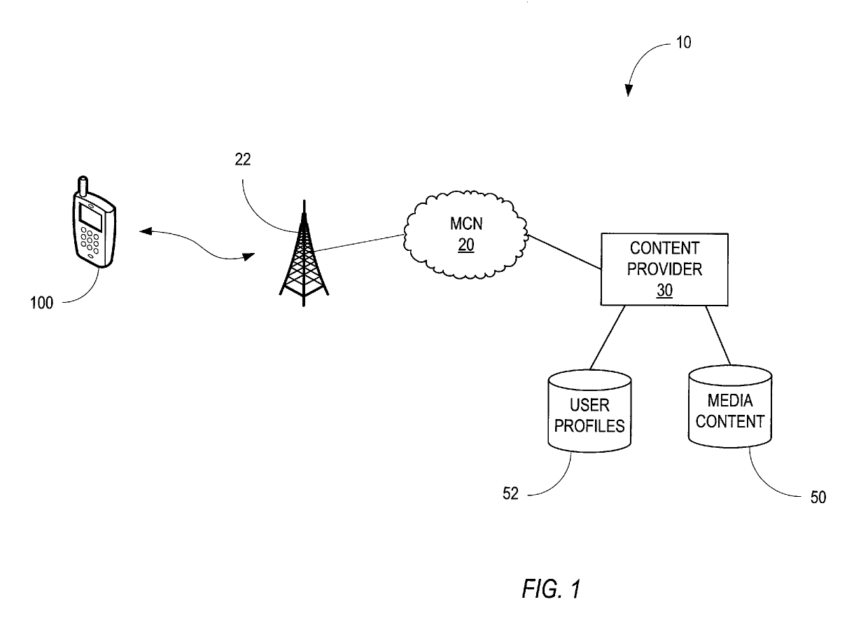

Referring now to the drawings, and particularly to FIG. 1, the present invention is described in the context of a communication network 10. The communication network 10 includes a mobile communication network 20 that provides voice and/or data services to mobile devices 100, and a content provider 30 for providing audio, video, and/or other media content to users of the mobile devices 100. The mobile communication network 20 typically comprises one or more base stations 22 for communicating with the mobile devices 100. The mobile communication network 20 may operate according to any known standard, such as GSM/GPRS, EDGE, WCDMA, WiFi, OFDM. The content provider 30 connects to the mobile communication network 20 to make media content available to the mobile devices 100. The content provider 30 may be located within the mobile communication network 20, or may reside in an external network, such as the Internet. The mobile device 100 may comprise a mobile phone, PDA, or laptop computer.

The content provider 30 comprises a server that stores media content for downloading to mobile devices 100. As used herein, the term “downloading” refers to the transfer of the media content from the content provider 30 to the mobile device 100 for storage and/or playback on the mobile device 100, and includes streaming of audio and/or video files for real time playback on the mobile device 100. The content provider 30 stores the available media content in a content database 50. The media content is typically identified by a title or other content identifier. The content provider 30 advertises the available titles (e.g., particular songs, movies, or broadcast programs) that it makes available. The user of the mobile device 100 may establish a session with the content provider 30, select a title for downloading, and download the selected title. The transfer of the media content from the content provider 30 to the mobile device 100 may be accomplished using known file transfer protocols such as MSRP, RTP, FTP, etc.

There may be circumstances when the mobile device 100 has only limited power available for downloading media content from a content provider 30. Therefore, the mobile device 100 implements intelligent, power-aware downloading to conserve battery power when the battery is low on power. To facilitate intelligent, power-aware downloading, the content provider 30 makes its media content available in different levels of content quality. The content quality may, for example, be specified in terms of resolution, bit rate, or other criterion. In general, the bandwidth required for downloading a particular title will vary with the content quality. Increasing the content quality will increase the bandwidth requirement by a corresponding amount, while decreasing the content quality will decrease the bandwidth requirement. When downloading media content from the content provider 30, the mobile device 100 determines the power it has available for downloading, selects a desired content quality based on current power availability, and downloads the media content with the selected content quality from the content provider 30.

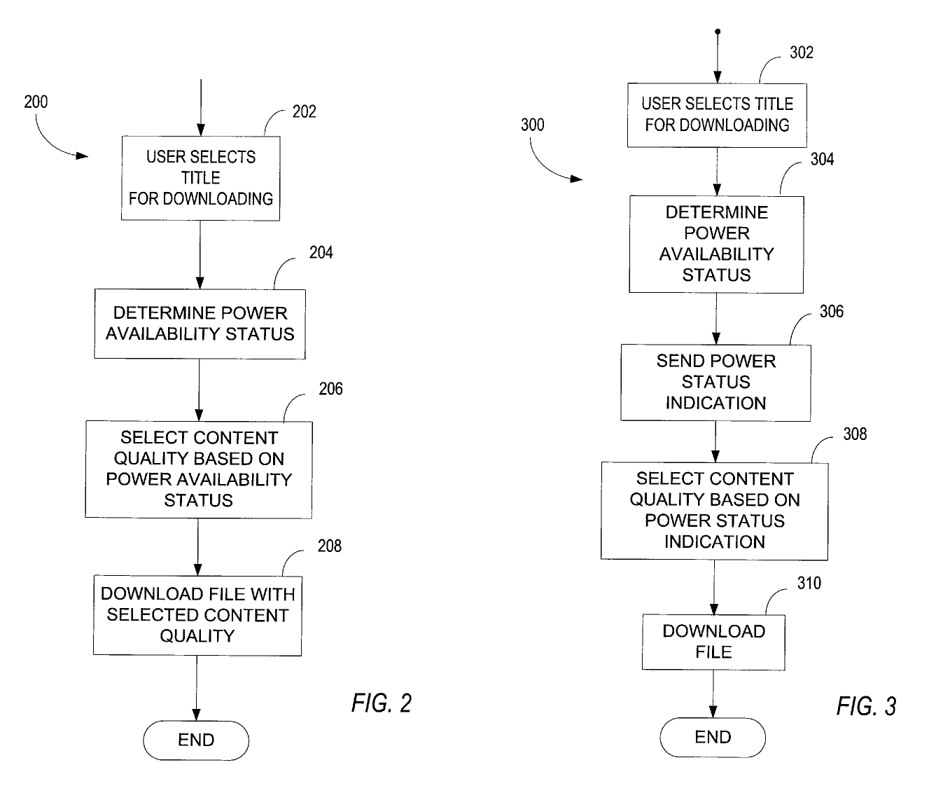

FIG. 2 illustrates an exemplary process 200 for implementing intelligent, power-aware downloading. The process 200 begins when the user selects a title for downloading (block 202). The mobile device 100 determines a power availability status (block 204), selects a desired content quality based on the power availability status (block 206), and downloads content file with selected content quality (block 208). To determine the power availability status (block 204), the mobile device 100 may check whether external power is available and/or the current power level of its battery. Depending on the power availability status, the mobile device 100 selects the content quality for the requested media content (block 206). For example, when an external power supply is available, the mobile device 100 may select the highest available content quality for the requested media content. If the mobile device 100 is operating on battery power, the mobile device 100 may select a lower content quality.

As one illustrative example, consider the situation when the requested media content is available in three levels of content quality. When the mobile device 100 is operating on external power, the mobile device 100 may select the highest content quality. When the mobile device 100 is operating on battery power, the mobile device 100 may select either the medium content quality or low content quality, depending on the current battery level. For example, the mobile device 100 may select the medium content quality when the battery level is 50% or greater, and the low content quality when the current battery level is less than 50%. In some embodiments, the mobile device 100 may select a content quality such that the bandwidth requirement for downloading the content is reduced proportional to the current battery level.

The selection logic implemented by the mobile device 100 may request user input or consider user preferences in determining the content quality. For example, the mobile device 100 may prompt a user to confirm the selected content quality, thus providing the user a chance to override or modify the selection. User preferences may be used to establish default settings for downloading media content. For example, the user preferences may include a default setting for situations when an external power supply is available, and a default setting for situations when battery power only is available. The default settings may control the manner in which the content quality is selected.

FIG. 3 illustrates an embodiment where the selection of content quality is performed by the content provider 30. The content provider 30 may store user profiles that include the user preferences for selecting content quality. In this embodiment, the user selects a title for downloading (block 302). The mobile device determines its power availability status (block 304) and sends a power availability indication to the content provider 30 (block 306). Based on the power availability indication and the user preferences stored in the user profile, the content provider 30 selects a content quality (block 308) and downloads the media content with the selected content quality (block 310).

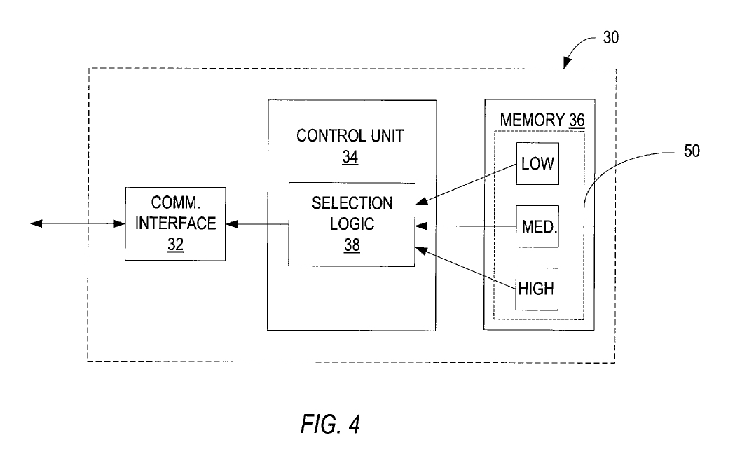

FIG. 4 illustrates an exemplary content provider 30 according to one embodiment. The content provider 30 comprises a communication interface 32, a control unit 34, and memory 36. The communication interface 32 enables communication with other devices. The communication interface 32 may, for example, comprise an Ethernet interface or other standard interface for communicating over IP networks. The control unit 34 is responsible for the overall operation of the content provider 30. The control unit 34 may comprise a microprocessor, microcontroller, hardware circuit, or combination thereof. Memory 36 stores the media content database 50, which contains the media content for downloading. Memory may also store a user profile database 52 (FIG. 1). Memory 36 may comprise a discrete memory device or a mass storage device, such as a magnetic disk drive or optical disk drive. In this embodiment, the media content database 50 stores multiple copies of each title. Each copy of each title has a different content quality (e.g., resolution, bit rate, etc.). The control unit 34 includes selection logic 38 to select the appropriate version of the title for downloading responsive to download requests from the mobile device 100 as previously described. The download request may explicitly identify the version of the title to download. Alternatively, the download request may specify a desired content quality and the selection logic 38 may select the version of the title that most closely corresponds to the specified content quality in the download request. In still other embodiments, the selection logic 38 may determine the content quality and select the version for downloading depending on user preferences stored in user profiles.

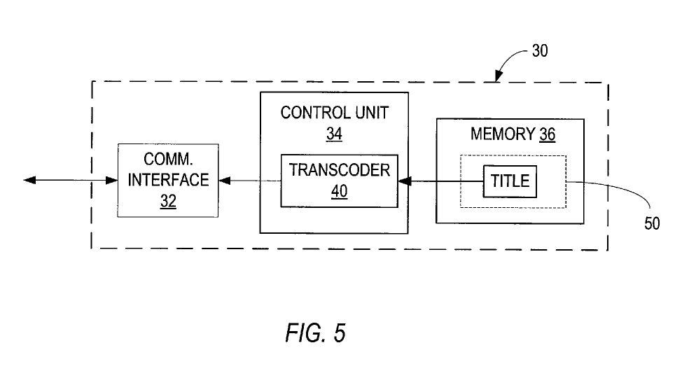

FIG. 5 illustrates an exemplary content provider 30 according to another embodiment. The content provider 30 includes a communication interface 32, control unit 34, and memory 36, as previously described. In this embodiment, the media content database 50 stores a single version of each title, which typically represents the highest available content quality. The control unit 34 includes a transcoder 40 for transcoding the media content. When a lower content quality is desired, the transcoder 40 transcodes the media content to generate the desired content quality for downloading to the mobile device 100.

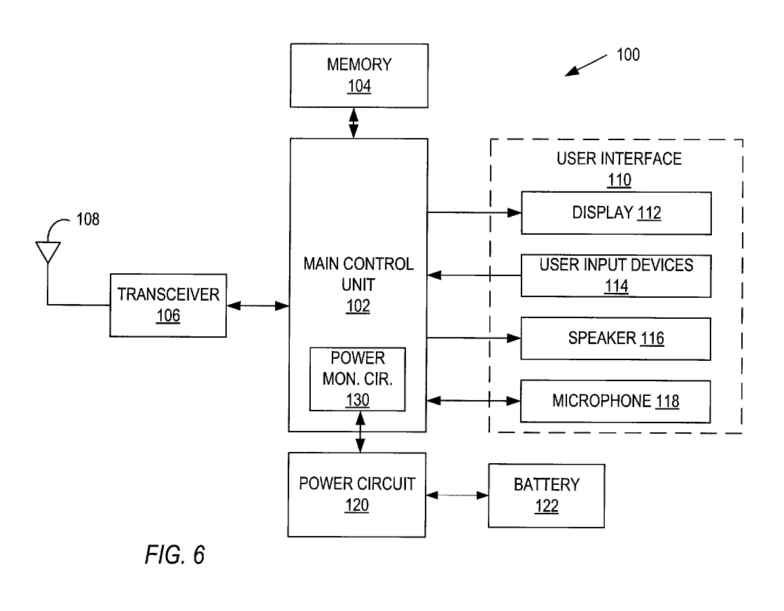

FIG. 6 illustrates an exemplary mobile device 100. The mobile device 100 comprises a main control unit 102, memory 104, a transceiver 106 connected to an antenna 108, user interface 110, and a power circuit 120. The main control unit 102 is responsible for overall operational control of the mobile device 100. The main control unit 102 may comprise one or more processors, microcontrollers, and/or hardware circuits. Memory 104 stores data and programs needed for operation. The memory 104 may comprise one or more discrete memory devices, including read-only memory, random access memory, flash memory, etc. Transceiver 106 comprises a conventional cellular transceiver for communicating with the mobile communication network 20. The transceiver 106 may operate according to known standards, such as GSM, WCDMA, UMTS, and OFDM.

User interface 110 comprises a display 112, one or more user input devices 114, speaker 116, and microphone 118. The main control unit 102 may output information to display 112 for viewing by the user. User input devices 114, such as keypads, navigation controls, joysticks, thumb wheels, etc., provide user input to the main control unit 102. Speaker 116 converts audio signals into audible sounds that can be heard by the user. Conversely, microphone 118 converts audible sounds into audible signals for input to the main control unit 102.

Power circuit 120 provides power to the main control unit 102 and other components. Power is typically supplied by an internal battery 122. In some embodiments, a power adapter may be used to connect the power circuit 120 to an external power supply. The main control unit 102 includes a power monitoring circuit 130 to monitor the power availability status of the mobile device 100. The power monitoring circuit 130 determines whether the mobile device 100 is operating off external power or internal battery power. Further, the power monitoring circuit 130 determines the current power level of the battery 122.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of downloading media content available in a plurality of content qualities to a mobile communication device, said method comprising:
determining a power availability status of said mobile communication device;
selecting a content quality depending on the power availability status; and
downloading the media content with the selected content quality.

2. The method of claim 1 wherein determining a power availability status of said mobile communication device comprises determining the availability of an external power source.

3. The method of claim 2 wherein selecting a content quality depending on the power availability status comprises selecting a higher content quality when an external power source is available and a lower quality when an external power source is unavailable.

4. The method of claim 1 wherein determining a power availability status of said mobile communication device comprises determining the power level of a battery.

5. The method of claim 4 wherein selecting a content quality depending on the power availability status comprises selecting a content quality that reduces bandwidth requirements when the power level of the battery is low.

6. The method of claim 5 wherein selecting a content quality depending on the power availability status comprises selecting a content quality that reduces bandwidth requirements proportionally with the power level of the battery.

7. The method of claim 1 wherein selecting a content quality depending on the power availability status is performed by the mobile communication device.

8. The method of claim 1 further comprising transmitting power availability status information from the mobile communication device to a content provider, and selecting the content quality by the content provider.

9. A mobile communication device comprising:
a power monitoring circuit to monitor the power availability status of the mobile communication device and to generate a power availability signal;
control logic configured to select a content quality responsive to the power availability signal; and
a receiver to download a media content with the desired content quality.

10. The mobile communication device of claim 9 wherein the power monitoring circuit monitors the availability of an external power source.

11. The mobile communication device of claim 10 wherein the control logic is configured to select a higher content quality when an external power source is available and a lower quality of said when an external power source is unavailable.

12. The mobile communication device of claim 9 wherein the power monitoring circuit monitors the power level of a battery.

13. The mobile communication device of claim 12 wherein the control logic is configured to select a content quality that reduces bandwidth requirements when the power level of the battery is low.

14. The mobile communication device of claim 13 wherein the control logic is configured to select a content quality that reduces bandwidth requirements proportionally with the power level of the battery.

15. A mobile communication device comprising:
a power monitoring circuit to monitor the power availability status of the mobile communication device;
control logic configured to transmit the power availability status with a download request to a content provider; and
a receiver to download a media content selected by the content provider responsive to said download request and based on said power availability status.

16. A content provider comprising:
memory to store a media content database; and
a control unit to:
receive a download request including a power availability status from a mobile communication device;
select media content from said media content database responsive to the download request and based on the power availability status; and
transmit the selected media content to the mobile communication device.

17. The content provider of claim 16 wherein the control unit comprises selection logic configured to:
determine a content quality based on the power availability status; and
select the media content based on the content quality.

18. The content provider of claim 16 wherein the control unit comprises a transcoder to transcode the media content based on the power availability status, and wherein the control unit transmits the selected media content by transmitting the transcoded media content to the mobile communication device.
